(19) United States
(12) Patent Application Publication
(10) Pub. No.: US 2005/0017089 A1
(43) Pub. Date: Jan. 27, 2005

(54) Finger operated spray pump

(76) Inventor: Marc Rohrschneider, Hagen (DE)

Correspondence Address: NIXON PEABODY, LLP, 401 9TH STREET, NW, SUITE 900, WASHINGTON, DC, 20004-2128, US

(21) Appl. No.: 10/622,772

(22) Filed: Jul. 21, 2003

(51) Int. Cl. A62C 11/00

(52) U.S. Cl. 239/333

(57) ABSTRACT

A finger operated spray pump has a liquid reservoir (1), a cylinder (3) for containing a portion of the liquid from the reservoir (1) which is connected at one end to an atomizer (5), a piston (6) sealingly mounted within the cylinder (3) and movable within the cylinder (3) in a spray stroke, a passageway (7) connecting the cylinder (3) with the liquid reservoir (1), a one way valve (8) at the passageway (7) for allowing a flow of liquid only from the supply of liquid (2) into the cylinder (3), and a finger operated actuator (9) which is displaceable relative to the liquid reservoir (1). The outer diameter of the piston (6) and the corresponding inner diameter of the cylinder (3) is between about 0.5 mm and about 4.0 mm, the nozzle diameter of the atomizer (5) is between 15 μm and 150 μm, the operating pressure within the cylinder (3) during the spray stroke with average finger force is between 10 bar and 400 bar and the atomizer (5), the cylinder (3), the piston (6) and the one way valve means (8) are designed to withstand the operating pressure.

### BACKGROUND OF THE INVENTION

1. Field of the Invention

The invention is related to finger operated spray pumps for spraying aerosol products by means of an atomizer arrangement. In particular, the invention directed to a finger operated spray pump having a liquid reservoir, a cylinder connected at one end to an atomizer to contain a portion of liquid from the reservoir, a part of which is to be ejected through the atomizer, a piston sealingly mounted within the cylinder and movable within and relative to the cylinder in a spray stroke such that the volume within the cylinder is reduced and a corresponding amount of the liquid in the cylinder is ejected through the atomizer, and in a return stroke such that the volume within the cylinder is increased and a corresponding amount of the liquid is drawn from the supply of liquid into the cylinder, a passageway means connecting the cylinder with the supply of liquid in the liquid reservoir, a one way valve means at the passageway means allowing a flow of liquid only from the supply of liquid into the cylinder, a finger operated actuator displaceable by finger pressure relative to the liquid reservoir in the spray stroke and in an opposite direction in the return stroke, displacement of the actuator inducing movement of the piston relative to the cylinder.

2. Description of Related Art

Conventional aerosol finger operated spray pumps typically produce pressures of 4 bar by means of a cylinder/piston-arrangement. Those pumps operate at pressures of much less than 10 bar anyway and do not lend themselves to higher pressures, as the cylinder/piston-valve arrangement is molded of thin plastics. However, in the prior art, it is understood that higher pressures cannot be achieved anyway, because the average operating force provided by a finger on the hand of an operator will normally be around 10 N and will, even in the extreme, not exceed 30 N.

Because of the low pressure generated in the cylinder/piston-arrangement of prior art finger operated spray pumps, the liquid to be atomised must be of low viscosity. This means that large quantities of solvent, such as alcohol and water, are required in the formulation of the liquid to lower the viscosity of the liquid. The high-level solvent formulations of liquid used in conventional aerosol finger operated spray pumps leads to sprays that are recognized by the user as “wet.” Reducing the amount of solvent means that the liquid becomes more viscous and more difficult spray. In order to increase the pressure in the spray pump, a mechanical advantage linkage is required so that the force that can be applied by a finger can be increased to a higher pressure. However, this reduces the piston stroke in comparison with the stroke length of the finger itself.

### SUMMARY OF THE INVENTION

A primary object of the present invention is to provide a finger operated spray pump system that is capable of atomising small doses of liquid in order to produce a “dry” spray of liquid, i.e., a spray of liquid using much less solvent than prior art aerosol finger operated spray pumps.

The above mentioned problem is solved by a finger operated spray pump of the initially mentioned type which, according to the invention, has an outer diameter of the piston and the corresponding inner diameter of the cylinder of between about 0.5 mm and about 4.0 mm, the nozzle-diameter(s) of the atomizer being between 15 μm and 150 μm, the operating pressure within the cylinder during the spray stroke with average finger force being between 10 bar and 400 bar, and the atomizer, the cylinder, the piston and the one way valve means being manufactured from materials and in a way to withstand the elevated operating pressure.

It has been realized according to the invention that a mechanical advantage linkage to increase the finger force can be avoided if the diameter of the cylinder/piston-system is reduced. A smaller diameter of the piston leads to a higher pressure which is obtainable by the spray pump. However, the nozzle-diameter of the atomizer must be adapted to the piston diameter. Finally, an operating pressure above 10 bar can be obtained only if the parts of the spray pump are manufactured from materials and in a way to withstand those elevated operating pressures.

Preferably, the piston stroke is adapted to the usual and comfortable stroke length of the original finger stroke of a person using the finger operated spray pump. For example, a piston stroke between 2 and 30 mm, preferably between about 15 mm and about 20 mm has been found advantageous.

A liquid dose per spray of between 5 μl and 300 μl, preferably between about 10 μl and about 100 μl, most preferably between about 20 μl and about 50 μl is preferable for many kinds of applications like perfume application.

It is particularly advantageous that the piston be made as a hollow piston, thus having the passageway means formed in the hollow piston. This is advantageous for both a variant with the piston fixedly attached to the liquid reservoir or one in which it is fixedly attached to the actuator. Preferred internal piston diameters are between about 0.2 mm and about 3.0 mm, preferably between about 0.5 mm and about 1.0 mm and the preferred embodiment of the hollow piston is as a metal capillary tube. The use of a metal capillary tube as a hollow piston simultaneously forming the passageway means is perfectly adapted to a high viscosity perfume oil as a preferred liquid for such finger operated spray pump.

There are a number of optional features to be realized in the spray pump, like a filter to protect the atomizer, a second one way valve means to prevent air ingress into the cylinder and an air vent means on a rigid liquid reservoir to allow pressure equalization in the liquid reservoir.

An interesting alternative to a rigid liquid reservoir may be a collapsible bag directly connected to the passageway means, perhaps within an outer more rigid protecting means.

The present invention relates to a finger operated spray pump that generates aerosol sprays of low doses with relatively small particles. It is ideally suited for formulations of liquid with a substantially reduced amount of solvent. The sprays generated give a “dry” feeling. They are well suited for applications such as perfumes, body sprays, hairsprays and other surface or space sprays.

Preferred embodiments of the invention are described below by way of examples with references to the accompanying drawings.

### BRIEF DESCRIPTION OF THE DRAWINGS

FIG. 1 is schematic cross-sectional view of a first embodiment of a finger operated spray pump with a rigid liquid reservoir and a dip tube,

FIG. 2 shows a modification of FIG. 1 with a one way valve means behind the atomizer,

FIG. 3 shows the same spray pump as FIG. 1 now with a one way valve means and a filter behind the atomizer,

FIG. 4 is schematic cross-sectional view of a second embodiment with a liquid reservoir in the form of a collapsible bag contained in an outer protective housing,

FIG. 5 is schematic cross-sectional view of a third embodiment, similar to the embodiment of FIG. 1, but with the atomizer in line with the cylinder in the actuator,

FIG. 6 is schematic cross-sectional view of a fourth embodiment with a hollow piston attached to the actuator and a cylinder fixedly attached to the liquid reservoir.

### DETAILED DESCRIPTION OF THE INVENTION

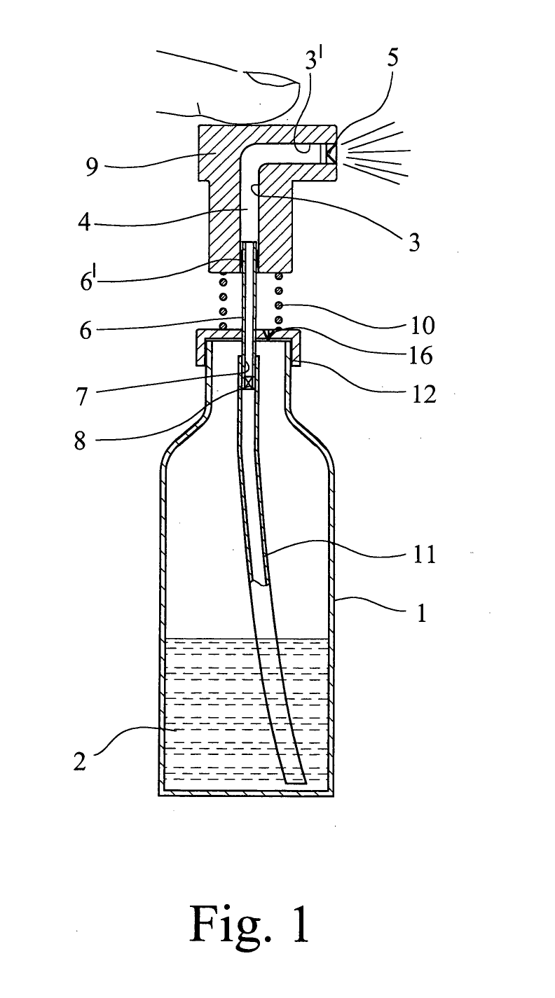

FIG. 1 shows a first embodiment of the invention which is a finger operated spray pump. This finger operated spray pump comprises a liquid reservoir 1, which, here, is in the form of a rigid container, intended to contain a supply of liquid 2. A cylinder 3 contains a pump volume of liquid 4. The cylinder 3 is connected at one end to an atomizer 5 and is intended to contain a portion of liquid from the reservoir 1, a part of which is to be ejected through the atomizer 5 in a spray stroke.

The atomizer 5 may be of the swirl chamber type with a swirl chamber in front of the nozzle exit. However, it may be of a double jet impeller type or of any other type realizing a mechanical brake up nozzle character. Ideas for such atomizer 5 can be found, for example, in published German Patent Application DE 101 54 237 A1. However, the atomizer 5 may as well produce a jet of liquid if a specific requirement has to be met.

FIG. 1 shows that a piston 6 is sealingly mounted within the cylinder 3 and is movable within and relative to the cylinder 3 in the spray stroke. The volume within the cylinder 3 is reduced and a corresponding amount of the liquid in the pump volume 4 of the cylinder 3 is ejected through the atomizer 5. In a return stroke, the piston 6 is movable within and relative to the cylinder 3 such that the volume within the cylinder 3 is increased and a corresponding amount of the liquid is drawn in from the liquid reservoir 1 into the cylinder 3. FIG. 1 shows the position of the parts of this embodiment at the end of the return stroke, eventually the beginning of the spray stroke.

A passageway means 7 connects the cylinder 3 with the supply of liquid 2 in the liquid reservoir 1. A one way valve means 8 at the passageway means 7 allows a flow of liquid only from the supply of liquid 2 into the cylinder 3, but not in the opposite direction. The actuator 9 has the atomizer 5 mounted at right angles to the cylinder 3 and connected to the cylinder 3 by way of a short connecting duct 3′.

A finger operated actuator 9 is indicated in FIG. 1 and a finger tip is schematically indicated there as well. By means of the force of the finger tip, the actuator 9 is displaceable relative to the liquid reservoir 1 in the spray stroke, i.e., downward in FIG. 1, and relative to the liquid reservoir 1, in an opposite direction in the return stroke (upward in FIG. 1, FIG. 1 showing the end of the return stroke). The displacement of the actuator 9 induces the movement of the piston 6 relative to the cylinder 3 and, in the spray stroke, the ejection of the liquid 2 within the pump volume 4 through the atomizer 5. The return stroke is induced by a return spring force. In the embodiment of FIG. 1, the return spring force is provided by a return spring 10, displayed here as a coil spring.

The piston 6 is sealingly mounted within the cylinder 3 so that a pressure build up can take place in the cylinder 3 on the spray stroke. In FIG. 1 the seal is indicated as a ring seal 6′ schematically. However, the seal between piston 6 an cylinder 3 may as well be a solid seal mounted at the piston 6 or a simple gap seal realized by an extremely small gap between piston 6 and cylinder 3 having a sealing characteristic for a liquid 2 of sufficient viscosity.

According to the invention, the outer diameter of the piston 6 and the corresponding inner diameter of the cylinder 3 is between 0.5 mm and about 4.0 mm, preferably between about 1.0 mm and about 3.0 mm, most preferably between about 1.5 mm and about 2.5 mm. The nozzle-diameter of the atomizer 5 is between 15 μm and 150 μm, preferably, between about 30 μm and about 100 μm. The operating pressure within the cylinder 3 during the spray stroke with average finger force is between 10 bar and 400 bar, preferably, between about 40 bar and about 200 bar, most preferably between about 50 bar and about 100 bar. The atomizer 5, the cylinder 3, the piston 6, and the one way valve means 8 are manufactured from materials and in a way to withstand the elevated operating pressure.

In the present, and preferred, embodiment the piston stroke is between 2 and 30 mm, preferably between about 15 mm and about 20 mm, which is comfortably adapted to the usual stroke of a finger of a person using the spray pump.

As explained above, this finger operated spray pump has the advantage that low doses of high viscosity liquid with a low amount of solvent can be sprayed. Preferably the liquid dose per spray stroke is between 5 μl and 300 μl preferably between about 10 μl and about 100 μl, most preferably between about 20 μl and about 50 μl.

FIG. 1 shows a substantially preferred embodiment in which the piston 6 is fixedly attached to the liquid reservoir 1 and is made as a hollow piston that simultaneously forms a passageway means 7 connected at one end directly or via a dip tube 11 to the supply of liquid 2 and at the other end to the cylinder 3. In fact, the piston 6 is fixedly attached to the liquid reservoir 1, whereas the cylinder 3 and the atomizer 5 are arranged within the actuator 9. The actuator 9, with cylinder 3 and atomizer 5, in total, is moved against the return spring force of the return spring 10, from the position in FIG. 1 downward toward the liquid reservoir 1 in the spray stroke. The passageway means 7 is integrated into the piston 6 which, itself, is a hollow piston.

In a preferred embodiment, the internal diameter of the hollow piston 6 is between about 0.2 mm and about 3.0 mm, preferably between about 0.5 mm and about 1.0 mm. In a particularly advantageous embodiment, the hollow piston 6 is a metal capillary tube.

In order to withstand the elevated operating pressures, in a preferred embodiment, the body of the actuator 9 is made from metal, preferably aluminium, or from highly pressure resistant plastic. Even the capillary tube may be made from a specifically selected plastic.

The one way valve means 8, in the embodiment of FIG. 1, is mounted at the inlet end of the passageway means 7, i.e., in this embodiment, the inlet end of the hollow piston 6. However, an alternative position may be the outlet end or a position between the inlet end and the outlet end. Specific positions of the one way valve means 8 for a high pressure spray pump can be obtained from published German Patent Application DE 195 36 902 A1, the positioning of the valve means 8, by itself, forming no part of the present invention. As a conventional solution, however, the passageway means 7 can be equipped at its inlet end with an additional check valve (ball valve).

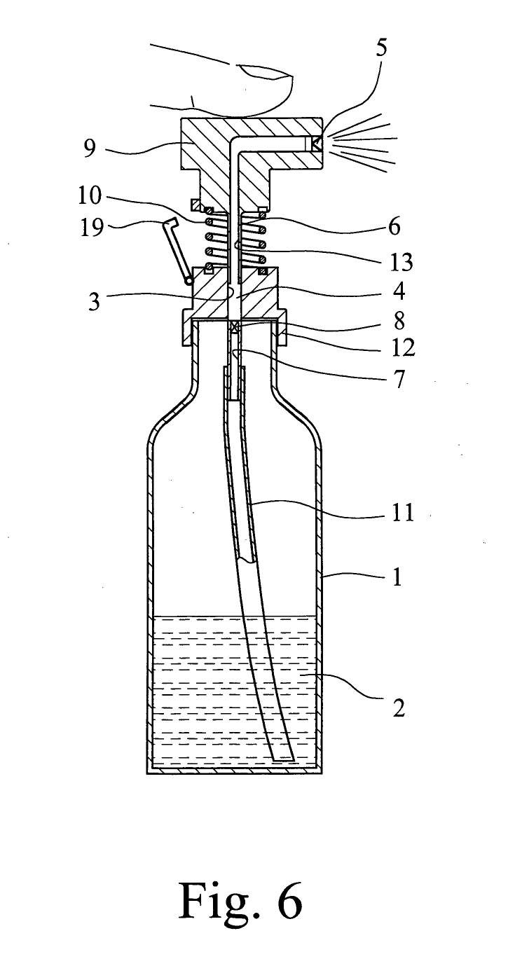

FIG. 6 shows an alternative embodiment of an otherwise very similar finger operated spray pump. The same parts of the spray pump as in FIG. 1 are identified with the same reference numbers and need no additional explanation. However, here, the piston 6 is fixedly attached to the actuator 9 and is a hollow piston that simultaneously forms a connecting means 13 that connects the cylinder 3 with the atomizer 5. Here, the cylinder 3 is fixedly attached to the liquid reservoir 1 and the piston 6 is fixedly attached to the actuator 9.

In accordance with an unillustrated third construction embodiment, the cylinder 3 is fixedly connected to the reservoir 1 via the passageway means 7 and the valve means 8. The cylinder 3 may be T-shaped with three arms respectively connected to the reservoir 1, the atomizer 5 and the sealingly mounted piston 6. The actuator 9 has a solid piston 6 in addition to the return spring 10. This is more a traditional construction of such a cylinder-piston-assembly.

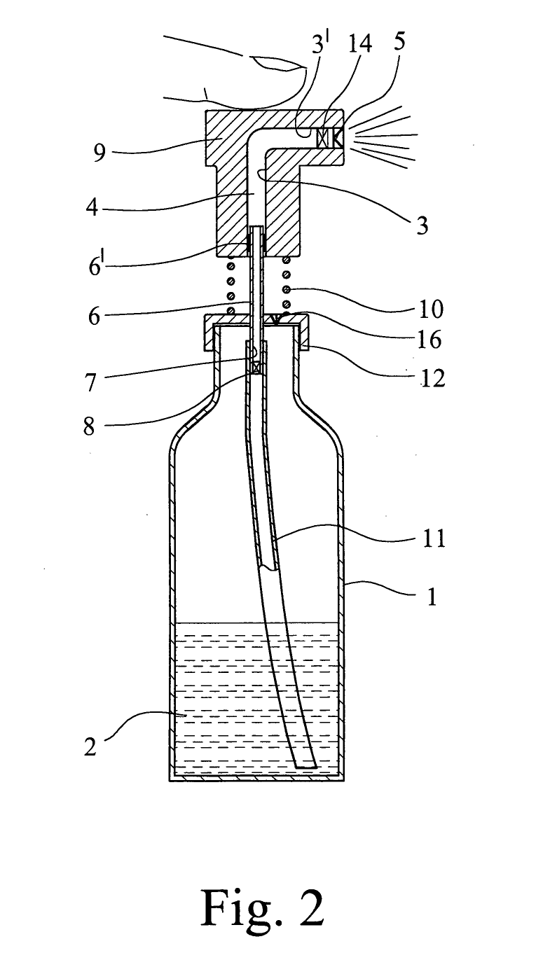

FIG. 2 shows the same spray pump as FIG. 1, but in addition shows that a filter 14 is provided between the cylinder 3 and the atomizer 5 to protect the atomizer 5.

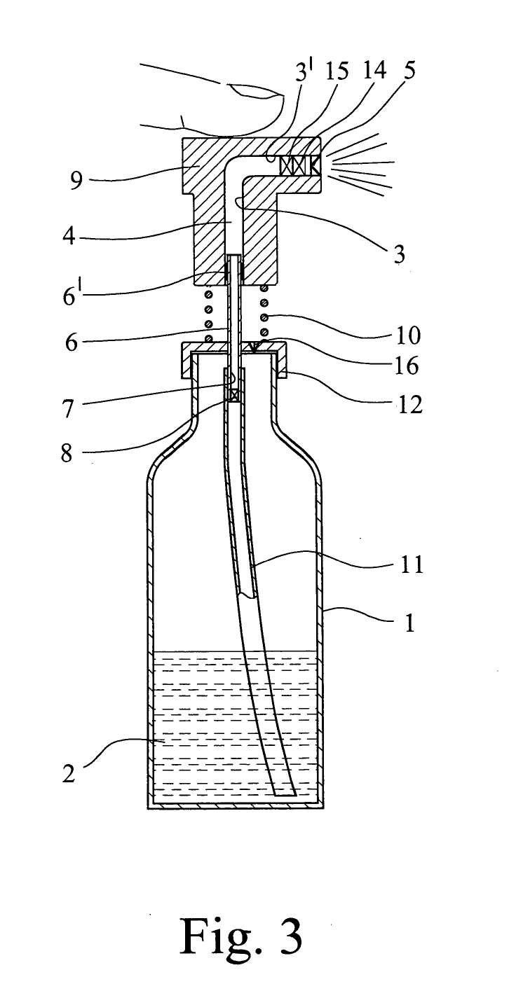

FIG. 3 shows the same spray pump as FIG. 2, but in addition that a second one way valve means 15 is provided between the atomizer 5 and the cylinder 3 for preventing air ingress into the cylinder 3, via the atomizer 5, during the return stroke.

All of FIGS. 1-3 show the liquid reservoir 1 as a rigid bottle with the passageway means 7 and piston 6 fixedly connected thereto, in particular, with a closure 12 of the reservoir 1 which is schematically shown in FIG. 1-3.

An air vent means 16 is disclosed for the embodiment with a rigid reservoir 1 as shown in FIG. 1-3 in the form of a valve with a flexible lip means. Also, the closure 12 of the reservoir 1 can integrate some means that allow air to enter for pressure equalization in the liquid reservoir 1. The air vent means 16 may be a mechanically operated one-way valve opened by a corresponding operating formation on the actuator 9 during the last leg of the spray stroke.

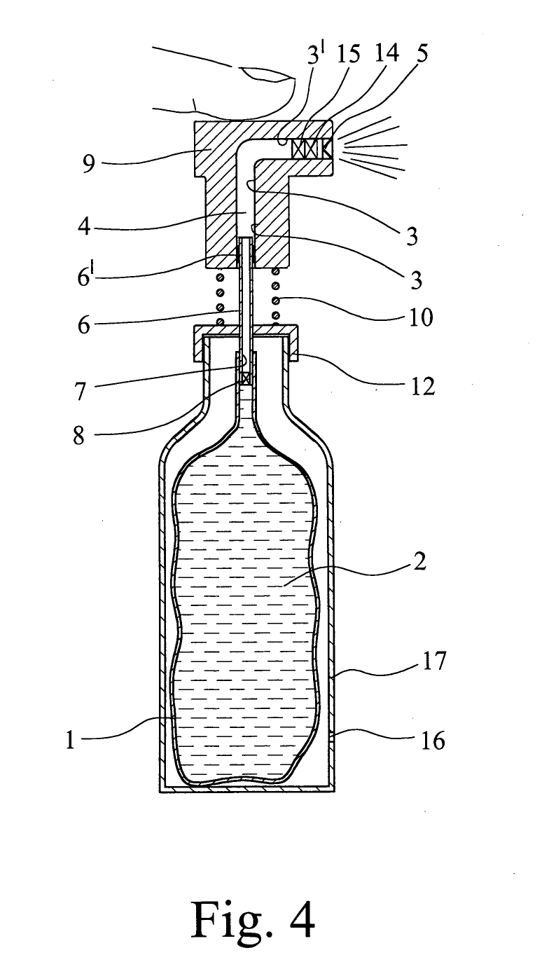

FIG. 4 shows a different embodiment which is otherwise similar to FIG. 3, but with a liquid reservoir 1 which is not a rigid bottle but is a collapsible bag directly connected to the passageway means 7. This collapsible bag use as the liquid reservoir 1, as such, is mounted within an outer protective housing 17 which, itself, is closed by a closure 12, the closure 12 again carrying the passageway means 7 and piston 6.

The outer protective housing 17 has an air vent means 16 which allows entry of air into the outer protective housing 17 following the stroke-wise emptying of the collapsible bag.

The liquid reservoir 1 in the form of a collapsible bag may be of a laminated type to prevent unwanted ingress of air (oxygen). A rigid reservoir 1 may be a long tube small enough in diameter to prevent air bubbles forming within the liquid.

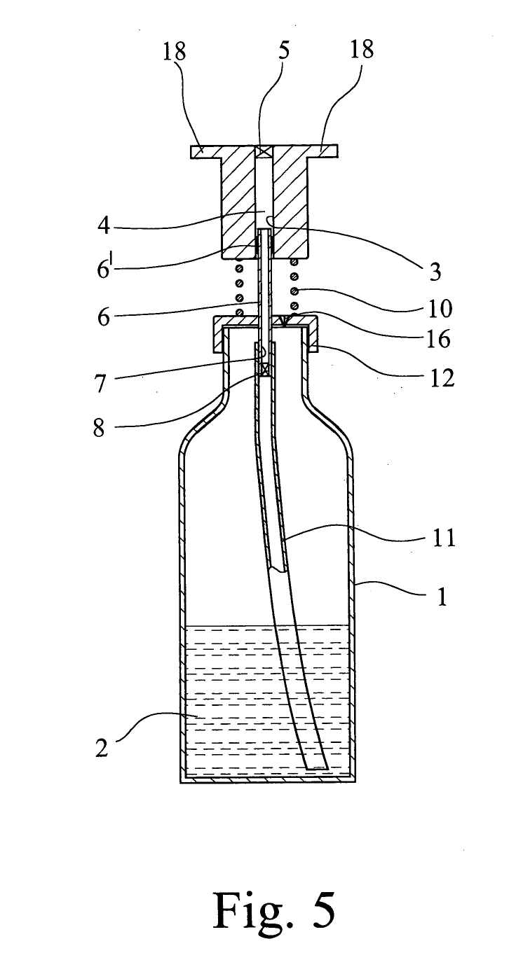

FIG. 5 shows a finger operated spray pump otherwise similar to FIG. 1 but with the atomizer 5 in line with the cylinder 3 and its pump volume 4. Finger pads 18 can be seen at the sides of the atomizer 5.

The finger operated spray pump may be used upside down even with a rigid reservoir 1 so that no dip tube 11 and only a short passageway means 7 is necessary.

To operate the finger operated spray pump according to the invention, explained with regard to FIG. 1, finger pressure is applied to the top of the actuator 9. Liquid within the pump volume 4 of the cylinder 3 is forced under pressure through the connecting duct 3′ and the atomizer 5 creating a spray outside of the atomizer 5. The mass mean particle diameter of the spray produced like this is between 5 and 100 μm.

The one-way valve means 8 prevents liquid from returning to the reservoir 1 during spraying. When the finger pressure is removed from the actuator 9, the return spring 10 returns the actuator 9 to its normal position (this is the return stroke). In doing so, liquid 2 is sucked up from the liquid reservoir 1 through the dip tube 11 and the passageway means 7 into the pump volume 4 in the cylinder 3. Another spray stroke is prepared and can be initiated immediately.

If a spray stroke is intended only with a fresh volume of liquid 2 in the cylinder 3, there may be a fixing means 19, fixing the actuator 9 on the reservoir 1 in its lower position (at the end of the spray stroke). Before activating the finger operated spray pump, this fixing means 19 must be released for a first return stroke. FIG. 6 shows such a fixing means 19 as a holding clip.

1. Finger operated spray pump comprising
a liquid reservoir for containing a supply of liquid,
an atomizer,
a cylinder having a volume therein for containing a portion of liquid from the reservoir, said cylinder being connected at one end to the atomizer for ejecting part of the liquid therein out through the atomizer,
a piston sealingly mounted within the cylinder and movable within and relative to the cylinder in a spray stroke during which the volume within the cylinder is reduced and a corresponding amount of the liquid in the cylinder is ejected through the atomizer, and in a return stroke during which the volume within the cylinder is increased and a corresponding amount of the liquid is drawn from the supply of liquid in the liquid reservoir into the cylinder,
a passageway means connecting the cylinder with the supply of liquid in the liquid reservoir,
a one way valve means at the passageway means allowing a flow of liquid only a direction from the supply of liquid into the cylinder,
a finger operated actuator which is displaceable relative to the liquid reservoir by finger pressure to produce the spray stroke, said actuator being displaceable in an opposite direction during the return stroke,
wherein the displacement of the actuator induces the movement of the piston relative to the cylinder,
wherein the piston has an outer diameter and the cylinder has a corresponding inner diameter that are between about 0.5 mm and about 4.0 mm,
wherein the atomizer has at least one nozzle, said at least on nozzle having a diameter of between 15 μm and 150 μm,
wherein the piston is adapted to produce an operating pressure within the cylinder during the spray stroke of between 10 bar and 400 bar from average finger applicable forces, and
wherein the atomizer, the cylinder, the piston and the one way valve means are manufactured of materials and in a way to withstand an operating pressure of up to about 400 bar.

2. Finger pump according to claim 1, wherein the piston has a stroke length of between 2 and 30 mm

3. Finger pump according to claim 1, wherein the piston has a stroke length of between about 15 mm and about 20 mm.

4. Finger pump according to claim 1, wherein the piston is adapted to produce a liquid dose per spray stroke of between 5 μl and 300 μl.

5. Finger pump according to claim 1, wherein the piston is adapted to produce a liquid dose per spray stroke of between about 10 μl and about 100 μl.

6. Finger pump according to claim 1, wherein the piston is adapted to produce a liquid dose per spray stroke of between about 20 μl and about 50 μl.

7. Finger pump according to claim 1, wherein the piston is fixedly attached to the liquid reservoir, is hollow piston and forms the passageway means, the passageway means being directly connected at one end to the supply of liquid and being connected at another end to the cylinder.

8. Finger pump according to claim 1, wherein the piston is fixedly attached to the liquid reservoir, is hollow piston and forms the passageway means, the passageway means being connected at one end to the supply of liquid via a dip tube and being connected at another end to the cylinder.

9. Finger pump according to any one of the claims 1, wherein the piston is fixedly attached to the actuator and is hollow, and wherein the piston forms a connecting means for connecting the cylinder with the atomizer.

10. Finger pump according to claim 9, wherein the piston has an internal diameter of between about 0.2 mm and about 3.0 mm.

11. Finger pump according to claim 9, wherein the piston has an internal diameter of between about 0.5 mm and about 1.0 mm.

12. Finger pump according to claim 8, wherein the piston has an internal diameter of between about 0.2 mm and about 3.0 mm.

13. Finger pump according to claim 8, wherein the piston has an internal diameter of between about 0.5 mm and about 1.0 mm.

14. Finger pump according to claim 12, wherein the piston is a metal capillary tube.

15. Finger pump according to claim 10, wherein the piston is a metal capillary tube.

16. Finger pump according to claim 1, wherein the actuator has a body made from metal.

17. Finger pump according to claim 1, wherein said metal is aluminium

18. Finger pump according to claim 1, wherein the actuator has a body made from a highly pressure resistant plastic.

19. Finger pump according to claim 8, wherein the piston is fixedly attached to the liquid reservoir, and wherein the cylinder and the atomizer are arranged within or as part of the actuator.

20. Finger pump according to claim 9, wherein the piston is fixedly attached to the liquid reservoir, and wherein the cylinder and the atomizer are arranged within or as part of the actuator.

21. Finger pump according to claim 9, wherein the cylinder is fixedly attached to the liquid reservoir, and wherein the piston is fixedly attached to the actuator.

22. Finger pump according to claim 10, wherein the cylinder is fixedly attached to the liquid reservoir, and wherein the piston is fixedly attached to the actuator.

23. Finger pump according to claim 1, wherein a filter is provided between the cylinder and the atomizer to protect the atomizer.

24. Finger pump according to claim 1, wherein a second one way valve means is provided between the atomizer and the cylinder for preventing air ingress into the cylinder, via the atomizer, during the return stroke.

25. Finger pump according to claim 1, wherein the liquid reservoir is a rigid bottle with the passageway means fixedly connected thereto.

26. Finger pump according to claim 25, wherein the rigid liquid reservoir is provided with an air vent means to allow pressure equalization in the liquid reservoir.

27. Finger pump according to claim 1, wherein the liquid reservoir is a collapsible bag directly connected to the passageway means.

28. Finger pump according to claim 1, further comprising a fixing means for fixing the actuator on the reservoir in a lowered position, said fixing means being releasable for a first return stroke before activating the spray pump.

29. Finger pump according to claim 1, further comprising a return spring for producing said return stroke of the finger operated actuator by a return spring force.

30. Finger pump according to claim 1, wherein the outer diameter of the piston and the corresponding inner diameter of the cylinder are between 1.0 mm and about 3.0 mm.

31. Finger pump according to claim 30, wherein the outer diameter of the piston and the corresponding inner diameter of the cylinder are between about 1.5 mm and about 2.5 mm.

32. Finger pump according to claim 1, wherein the diameter of the at least one atomizer nozzle is between about 30 μm and 100 μm.

33. Finger pump according to claim 1, wherein the operating pressure that the piston is adapted to produce within the cylinder during the spray stroke from average finger applicable forces is between about 40 bar and about 200 bar.

34. Finger pump according to claim 1, wherein the operating pressure that the piston is adapted to produce within the cylinder during the spray stroke from average finger applicable forces is between about 50 bar and about 100 bar.

35. Finger operated spray pump comprising
a liquid reservoir for containing a supply of liquid,
an atomizer,
a cylinder having a volume therein for containing a portion of liquid from the reservoir, said cylinder being connected at one end to the atomizer for ejecting part of the liquid therein out through the atomizer,
a piston sealingly mounted within the cylinder and movable within and relative to the cylinder in a spray stroke during which the volume within the cylinder is reduced and a corresponding amount of the liquid in the cylinder is ejected through the atomizer, and in a return stroke during which the volume within the cylinder is increased and a corresponding amount of the liquid is drawn from the supply of liquid in the liquid reservoir into the cylinder,
a passageway means connecting the cylinder with the supply of liquid in the liquid reservoir,
a one way valve means at the passageway means allowing a flow of liquid only a direction from the supply of liquid into the cylinder,
a finger operated actuator which is displaceable relative to the liquid reservoir by finger pressure to produce the spray stroke, said actuator being displaceable in an opposite direction during the return stroke,
wherein the displacement of the actuator induces the movement of the piston relative to the cylinder,
wherein the piston has an outer diameter and the cylinder has a corresponding inner diameter that are between about 1.5 mm and about 2.5 mm,
wherein the atomizer has at least one nozzle, said at least on nozzle having a diameter of between 30 μm and 100 μm,
wherein the piston is adapted to produce an operating pressure within the cylinder during the spray stroke of between 50 bar and 100 bar from average finger applicable forces, and
wherein the atomizer, the cylinder, the piston and the one way valve means are manufactured of materials and in a way to withstand an operating pressure of up to at least about 100 bar.

36. Finger pump according to claim 35, wherein the piston has a stroke length of between about 15 mm and about 20 mm.

37. Finger pump according to claim 35, wherein the piston is adapted to produce a liquid dose per spray stroke of between about 20 μl and about 50 μl.

38. Finger pump according to claim 35, wherein the piston is fixedly attached to the liquid reservoir and is a hollow piston which forms the passageway means, the passageway means being directly connected at one end to the supply of liquid and being connected at another end to the cylinder.

39. Finger pump according to claim 35, wherein the piston is fixedly attached to the liquid reservoir, is hollow piston and forms the passageway means, the passageway means being connected at one end to the supply of liquid via a dip tube and being connected at another end to the cylinder.

40. Finger pump according to claim 35, wherein the piston is fixedly attached to the actuator and is hollow, and wherein the piston forms a connecting means for connecting the cylinder with the atomizer.

41. Finger pump according to claim 40, wherein the piston has an internal diameter of between about 0.2 mm and about 3.0 mm.

42. Finger pump according to claim 40, wherein the piston has an internal diameter of between about 0.5 mm and about 1.0 mm.

43. Finger pump according to claim 39, wherein the piston has an internal diameter of between about 0.2 mm and about 3.0 mm.

44. Finger pump according to claim 39, wherein the piston has an internal diameter of between about 0.5 mm and about 1.0 mm.
